(19) United States
(12) Patent Application Publication
(10) Pub. No.: US 2002/0198820 A1
(43) Pub. Date: Dec. 26, 2002

(54) Method and apparatus for lease buyout

(76) Inventor: Timothy J. Mills, Carol Stream, IL (US)

Correspondence Address: BUCKLEY, MASCHOFF, TALWALKAR, & ALLISON, 5 ELM STREET, NEW CANAAN, CT, 06840, US

(21) Appl. No.: 09/886,537

(22) Filed: Jun. 21, 2001

(51) Int. Cl. G06F 17/60

(52) U.S. Cl. 705/38; 705/37

(57) ABSTRACT

A system, apparatus, method, computer program code and means for lease buyout includes identifying an alternative financial product by calculating a payment difference between a loan and a lease for an item, where the loan and the lease have a term, and where the payment difference includes at least a recurring payment difference equal to the difference between a recurring payment for the loan and a recurring payment for the lease. An investment option is identified which has an expected rate of return. An investment value at the end of the term is calculated based on investment of the payment difference amount in the investment option.

### CROSS-REFERENCE TO RELATED APPLICATIONS

This application is related to co-pending and commonly-owned U.S. patent application Ser. No.______, filed Jun. 21, 2001 (on even date herewith), Attorney Docket No. G03.011 for “METHOD AND APPARATUS FOR LOAN APPROVAL”, U.S. patent application Ser. No.______, filed Jun. 21, 2001 (on even date herewith), Attorney Docket No. G03.012 for “METHOD AND APPARATUS FOR RISK BASED PRICING”, and U.S. patent application Ser. No.______, filed Jun. 21, 2001 (on even date herewith), Attorney Docket No. G03.013 for “METHOD AND APPARATUS FOR MATCHING RISK TO RETURN”, the contents of each of which are incorporated by reference in their entirety for all purposes.

### FIELD OF THE INVENTION

The present invention relates to financial products and services. More particularly, embodiments of the present invention relate to financing alternatives.

### BACKGROUND OF THE INVENTION

Millions of automobiles are sold in the U.S. and around the world each year, making the automobile industry one of the largest industries in the world. This huge industry has created another large industry—the automotive finance industry. A large majority of automobiles sold each year are financed in one form or another. Two primary financing techniques are loans and leases. Automobile loans are contracts in which a lender (such as a financial institution or financing company) provides funds to a buyer, typically secured by an interest in the automobile. The price and availability of such financing is often based on the buyer's creditworthiness and the value of the automobile. The amount of the financing is typically less than the value of the automobile, requiring some funds to be paid directly by the buyer (usually in the form of a down payment).

Automobile leases are contracts between an owner of the automobile (typically a financial institution or financing company) and the “buyer” (who in this case is actually a user or renter of the automobile) where the owner conveys exclusive possession, control, use, or enjoyment of the automobile for a specified rent and a specified term after which the automobile reverts to the owner. Some buyers prefer loans to leases because a loan allows the buyer to own the automobile once the loan is paid off. A buyer who wishes to purchase a vehicle at the end of a lease must typically pay a pre-determined “residual value” of the automobile. This residual value is typically agreed-to at the beginning of the lease. Some buyers prefer leases to loans because the monthly lease payment is typically lower than a monthly loan payment for the same automobile. Further, the amount of money that must be paid in advance to take possession of the vehicle is often much lower for leases than for loans (e.g., loans typically require a down payment of between 10-40% of the vehicle price). Both loans and leases can be lucrative to the financial institutions involved.

In many situations, automobile dealers enjoy at least two benefits from automobile financings. First, the dealer typically makes a profit from the sale of the automobile. This benefit accrues regardless of whether the automobile was sold using a loan or a lease. Second, the dealer can make a profit on the financing as an intermediary between the buyer and the financial institution. This benefit, however, only occurs if the dealer helps to arrange the financing or lease. Many buyers pre-arrange for financing through a lender or leasing agent of their choice, disintermediating the dealer. Other buyers take advantage of state laws that allow them to secure their own financing after taking delivery of the vehicle. Again, this removes the dealer from the financing or lease transaction, reducing the dealer's profit from the sale of the vehicle.

Similarly, financial institutions or financing companies that offer leases lose potential customers when automobile buyers secure financing or loans on their own. It would be desirable to provide a method and system that would allow dealers and/or financial institutions to encourage buyers to accept a lease rather than a loan. It would also be desirable to provide a financing technique that allows a buyer to automatically create a fund that is designed to be used to pay off the residual value of the item at the end of the lease if the buyer decides to purchase the vehicle. Preferably, the financing technique may be used in the sale of a number of different types of items, including automobiles.

### SUMMARY OF THE INVENTION

To alleviate the problems inherent in the prior art, and to provide an improved financing technique, embodiments of the present invention provide a system, apparatus, method, computer program code and means for lease buyouts.

In one embodiment, a system, apparatus, method, computer program code and means for lease buyout includes identifying an alternative financial product by calculating a payment difference between a loan and a lease for an item, where the loan and the lease have a term, and where the payment difference includes at least a recurring payment difference equal to the difference between a recurring payment for the loan and a recurring payment for the lease. An investment option is identified which has an expected rate of return. An investment value at the end of the term is calculated based on investment of the payment difference amount in the investment option.

According to one embodiment, the alternative financial product is offered to a buyer if the investment value is greater than or equal to a residual value of the item at the end of the term. The investment option may be comprised of one or more investments of different types.

According to one embodiment, if the buyer accepts the alternative financial product, a periodic payment received from the buyer is split into at least two payments, with one payment being applied to satisfy said recurring lease payment, and another payment being applied to the investment option.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a flow diagram depicting a process for evaluating a transaction for potential lease buyout according to one embodiment of the present invention.

FIG. 2 is a flow diagram depicting a process for conducting a lease buyout transaction according to one embodiment of the present invention.

FIG. 3 is a block diagram of a system consistent with the present invention.

FIG. 4 is a block diagram of a sales device of the system of FIG. 3 pursuant to an embodiment of the present invention.

FIG. 5 is a table depicting an exemplary application database used in the system of FIG. 3.

FIG. 6 is a table depicting an exemplary lease buyout database used in the system of FIG. 3.

### DETAILED DESCRIPTION OF THE INVENTION

Applicants have recognized that there is a need to provide further options to sellers of products (such as automobile dealerships selling automobiles) to encourage buyers to accept financing arrangements that benefit the seller as well as the buyer. Applicants have discovered a technique which benefits both the seller and the buyer and which may be used to encourage buyers to accept product leases rather than loans.

For the purposes of describing embodiments of the present invention, a number of terms will be used herein. As used herein, the term “financial institution” will be used to refer to a bank, credit union, financing agency, leasing agent, or other lender, lessor or entity which extends credit to or otherwise underwrites financial products such as loans and/or leases to applicants. As used herein, the term “lender” or “lessor” may be used interchangeably with the term “financial institution”.

As used herein, the term “buyer” is used to refer to an individual or entity that is applying for approval of a financial product such as a lease or loan offered by a financial institution.

An “item” to be purchased may be any good or service that may be acquired by a buyer using either a loan or a lease. Throughout this disclosure, automobiles (which is used to refer to cars, trucks, and other motorized vehicles) will be referenced as a particular type of item that is particularly suited for purchase using features of the present invention. Those skilled in the art, upon reading this disclosure, will recognize that other types of goods or services may also be sold using features of embodiments of the present invention.

As used herein, a “seller” is the individual or entity attempting to sell a lease buyout financial product of the present invention to a buyer. The seller may be any of a number of different entities, working alone or in concert. For example, in one currently preferred embodiment to be discussed herein, the seller may be an automobile dealership acting on behalf of, or in cooperation with, a financial institution. In other embodiments, the seller may be the financial institution acting on its own behalf. In other embodiments (referred to as “indirect” sales), the seller may be an entity (such as an automobile dealership) that resells the lease buyout financial product to another party (such as a financial institution). Those skilled in the art will recognize that any of a number of different entities or combinations of entities may act as “sellers” as that term is used herein.

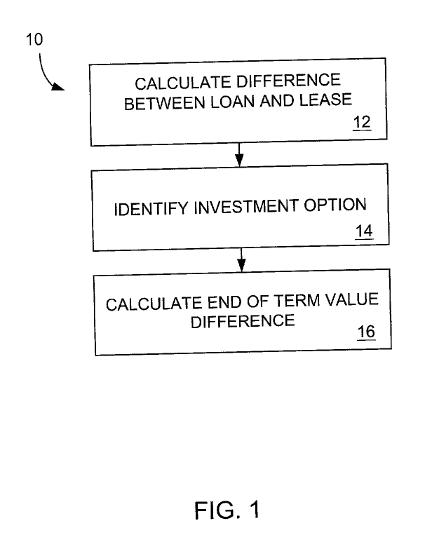

Referring now to FIG. 1, an overview of embodiments of the present invention are shown as a process 10. Process 10 may be conducted by, or on behalf of, an entity (such as, for example, a financial institution, a dealership, etc.) which offers lease buyout products pursuant to the invention. Processing begins at 12 where the difference between a loan for an item and a lease for the item are calculated. This difference may be one or more dollar amounts representing a financial difference between a loan for the item and a lease for the item. The dollar amount is typically positive (that is, the cost of a loan to purchase an item is typically greater than the cost of a lease to rent the item).

Once this dollar amount has been calculated, processing continues to 14 where an investment option is identified. According to the invention, some or all of the dollar amount identified at 12 is invested for the term of the lease in one or more investment vehicles. These investment vehicles are identified at 14. Identification at 14 may also include the identification or estimation of a potential rate of return for the identified option.

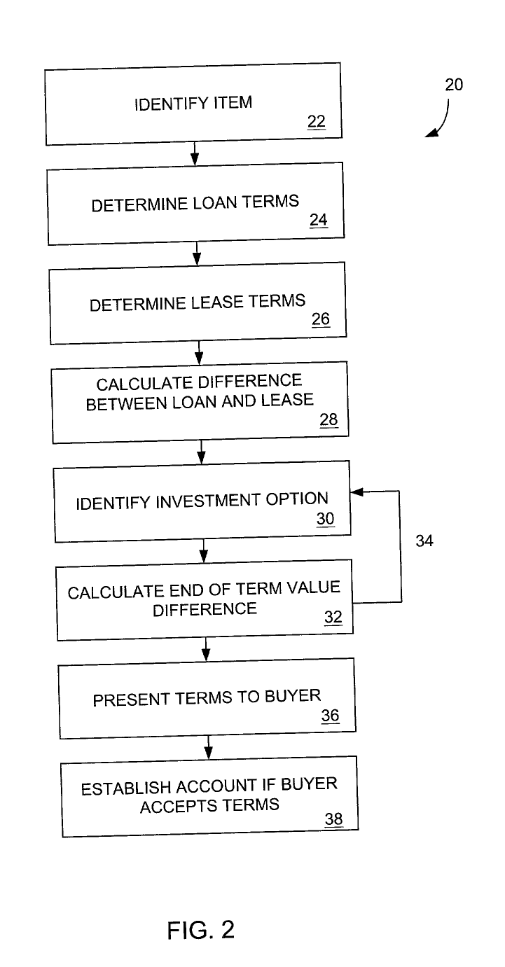

Processing continues at 16 where the system operates to calculate an end of term value difference. A lease typically identifies a residual value for the item at the end of the lease. Processing at 16 compares this residual value of the item with the total dollar amount which would accrue if the amount of the difference (calculated at 12) were deposited in the investment vehicles identified at 14. If the accrued value is greater than the residual value, the buyer may be encouraged to accept a lease with the lease buyout option of the invention rather than obtaining financing elsewhere. Further details of embodiments of the invention will be described below in conjunction with FIG. 2. The result is a system which allows sellers of items and financial institutions the opportunity to participate in the financing of an item even after the buyer has identified other financing. Sellers, such as automobile dealerships, and financial institutions offering products pursuant to the invention will realize greater profits as a result. Further, buyers will enjoy a further financing option in addition to standard loans and leases. Lease buyout options pursuant to the present invention enjoy some benefits of both leases and loans.

Further details of embodiments of the present invention will now be described by referring to FIG. 2 where a process 20 for establishing a lease buyout is shown. Process 20 may be conducted by, or on behalf of, an entity (such as an automobile dealership, or financial institution) which offers lease buyout products pursuant to the present invention. In one embodiment, some or all of process 20 may be performed by an agent of a financial institution. For example, in an embodiment used in the automobile industry, each of the steps of process 20 may be performed by an automobile dealership as an agent for a financial institution. As a specific example, process 20 may be performed by an automobile dealership once a buyer has selected an automobile to purchase and after the buyer has indicated an interest in financing the automobile using a loan (for which the buyer may have pre-arranged financing or may have simply indicated an interest). Process 20 may be conducted by the dealership to provide the buyer with a further financing option (in addition to the loan option) that provides potentially attractive benefits to the buyer.

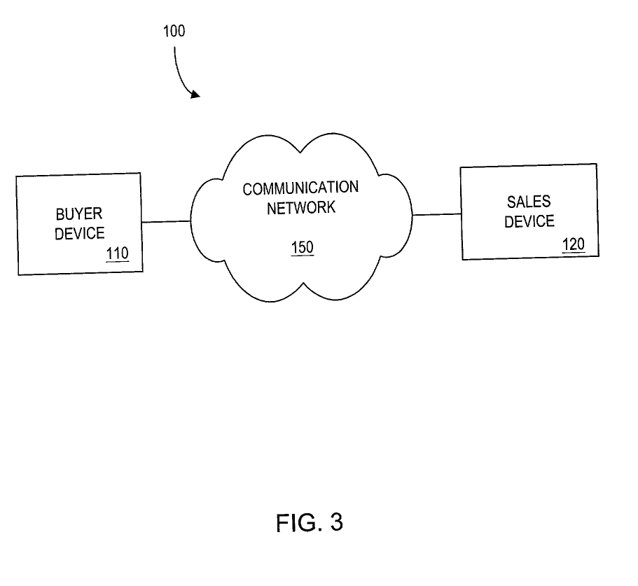

Processing begins at 22 where the item to be purchased or leased by the buyer is identified. Applicants believe that embodiments of the invention are particularly desirable for use with automobiles and other vehicles (e.g., the “item” identified at 22 may be a particular vehicle), but those skilled in the art will recognize that other products and services may also be sold using embodiments of the present invention. For example, the item may be identified at 22 by inputting information into a computer system (such as the system 100 of FIG. 3 which will be described further below). Information identifying the item may include a price of the item, a unique identifier of the item (such as an automobile VIN number), or other information typically used in the art to identify such items.

Processing continues at 24 where loan terms for the item are determined. In one embodiment, features of the invention are used to offer a financing alternative where the buyer has already secured financing. In such a case, processing at 24 includes identifying the loan terms from that financing. In particular, the terms identifying the duration (or “term”) of the loan, the monthly or periodic cost of the loan and the down payment required (if any) are identified. Taxes, handling, and other fees needed to obtain the financing may also be identified at 24. In some situations, the buyer may not already have financing. In these situations, processing at 24 may involve identifying potential loan terms (e.g., based on market rates or existing loan offers known to the seller). In some embodiments, multiple sets of loan terms may be identified (e.g., terms may be established for a loan of 36 months and a loan of 60 months).

Processing continues at 26 where lease terms for the item are determined. In one embodiment, the lease terms are determined based on current offerings made by or available to the seller for the particular item identified at 22. Lease terms identified at 26 may include: the duration (or “term”) of the lease, the monthly or periodic cost of the lease, the down payment required (if any), and the residual value of the item at the end of the term. Other fees needed to obtain the lease may also be identified at 26 (e.g., taxes, handling, or other fees). In some embodiments, multiple sets of lease terms may be identified (e.g., the buyer may be given terms for a 36 month and a 60 month lease). In one embodiment, the lease terms are calculated for leases which have the same duration as the loan or loans identified at 24.

Processing continues at 28 where the difference between a loan and a lease for the item is calculated. This difference which is calculated at 28 is the financial difference between the loan and the lease. This financial difference may include a difference between a down payment (which will typically be required for a loan, but may not be required for a lease), a difference between other acquisition fees or document costs which may be required, and a difference between the periodic or monthly payments required. According to one embodiment of the invention, an amount approximately equal to this difference will be automatically invested for the buyer if the buyer accepts the lease buyout product. The buyer will make a total monthly payment equal to the loan payment, with the funds split between making the lease payment and making an investment. The total amount invested is preferably selected to mature to an amount greater than the residual value of the item at the end of the lease, allowing the buyer to acquire title to the vehicle without further payment.

A simplified example of calculations at 28 follows. A loan for a $20,000 automobile may require that the buyer put 20% down ($4,000). The loan, at 8% annual percentage rate (APR) over 60 months will require monthly payments of approximately $325. A sample lease for the same vehicle may require monthly payments of approximately $275 with a residual vehicle value at the end of term of $7,000. Thus, the difference calculated at 28 is: the loan requires $4,000 more up front and an extra $50.00 each month. If multiple sets of loan and lease terms are identified at 24 and 26, processing at 28 may include several comparisons.

Processing continues at 30 where an investment option is identified. According to the invention, some or all of the difference between the loan and the lease will be placed into one or more investment vehicles. At 30, the particular investment vehicle(s) are identified. This identification may be performed by presenting the buyer with a list of authorized investment options, or by allowing the buyer to identify the investment option of his or her preference. Processing at 30 also includes estimating a rate of return which may be realized from the identified investment vehicle(s). Any of a number of different investment options may be utilized with embodiments of the present invention. In one embodiment, low risk options are preferred to reduce the risk of loss for buyers. Potential low risk investment options include, for example, treasury bills, money market funds, certificates of deposit, or other commonly available investment options. In some embodiments, investment options may also include publicly traded securities such as stocks, bonds, stock or bond funds, or the like. In some embodiments, more than one investment may be selected. In such embodiments, processing at 30 includes identifying a desired allocation between multiple investments (e.g., as a dollar amount each month, as a percentage of funds invested, or the like).

Continuing with the example introduced above, the buyer of the automobile may select an investment option where all funds would be deposited in a money market fund estimated to realize an annual return of 6%.

Processing continues to 32 where the system of the invention calculates the end of term value difference between the loan and the lease options. Continuing with the example introduced above, the calculation at 32 would proceed as follows. The 60 month loan required a down payment of $4,000 more than the lease. The 60 month loan required an additional $50.00 each month more than the lease. Assuming these funds were deposited (the down payment deposited on day one, and the monthly payments deposited monthly) into the selected investment option which yields 6% annually, the deposited funds would grow to an amount of approximately $8,883.40 at the end of the 60 month term.

Comparison at 32 indicates that this end of term amount is greater than the residual value of the vehicle ($7,000) under the lease option. Therefore, the buyer may be interested in accepting the lease buyout option in which he or she makes monthly payments which are equal to the loan payments, but where the funds are split into two payments: a lease payment and an investment payment. The investment payment, in one embodiment, is equal to the difference identified at 28.

In some situations, the end of term value at 32 may not be greater (or sufficiently greater) than the residual value of the vehicle at the end of the lease. In these situations, processing may revert via 34 to step 30 where a different investment option or allocation may be selected (e.g., having a higher expected rate of return). Processing may revert via 34 to allow the buyer to analyze the potential performance of other investment mixes or alternatives as well. In some embodiments, processing may revert to 26 to allow the buyer to create a loan buyout product with different lease terms as well.

Once an acceptable investment option has been selected, processing continues at 36 where terms of the lease buyout are presented to the buyer for review and acceptance. This presentation may be performed electronically (e.g., such as in embodiments where the system is used in a networked fashion and the buyer is remotely located from the seller), physically, via mail, or the like.

Processing continues at 38 where a lease buyout account is established if the buyer accepts the terms presented at 36. This lease buyout account may be an actual deposit account established at a financial institution or other entity, into which a lease buyout payment amount is deposited. The entity maintaining the lease buyout account will then divide the lease buyout payment amount into payments which are applied towards: (1) the lease payment; and (2) the investment option payment(s). Continuing the example introduced above, the monthly lease buyout payment amounts of $325 may be deposited by the buyer into his lease buyout payment account. The financial institution then splits the $325 in the account into: (1) a $275 lease payment; and (2) a $50.00 deposit into the money market fund designated by the buyer. By automatically making these payments for the buyer, the buyer is relieved of the need to track and budget for making both payments on a regular basis.

Details of one embodiment of a system for implementing features of the invention will now be described by referring to FIG. 3. A system 100 pursuant to one embodiment of the present invention is shown. According to one embodiment, features of the present invention may be used to allow lease buyouts between a buyer and a seller over a network such as the Internet. According to other embodiments of the present invention, lease buyouts may occur in a system where buyers and sellers operate the same device. Both embodiments will be described by first referring to FIG. 3, where system 100 includes a buyer device 110 in communication with a sales device 120.

As used herein, devices (such as buyer device 110 and sales device 120) may communicate, for example, via a communication network 150, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology. Security measures, known to those skilled in the art, may be used with embodiments of the present invention to ensure data security and privacy as data is moved between devices and stored at devices such as devices 110 and 120.

In one embodiment of the present invention, each buyer device 110 communicates with one or more remote, World Wide Web (“Web”)-based sales devices 120 (e.g., configured as a Web-server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Buyer device 110 and sales device 120 may be any devices capable of performing the various functions described herein. For example, either of buyer device 110 and sales device 120 may be, for example: a Personal Computer (PC), a portable computing device such as a Personal Digital Assistant (PDA), or any other appropriate computing, storage and/or communication device.

Note that although a single buyer device 110 and a single sales device 120 are shown in FIG. 3, any number of buyer and/or sales devices 110,120 may be included in system 100. In one embodiment, system 100 will include a plurality of buyer devices 110 in communication with one or more sales devices 120. In another embodiment, buyer device 110 is the same as sales device 120, and is located at, for example, a sales location where goods or services are sold which may be financed using features of the present invention. For example, the device may be located at an automobile dealer's show room.

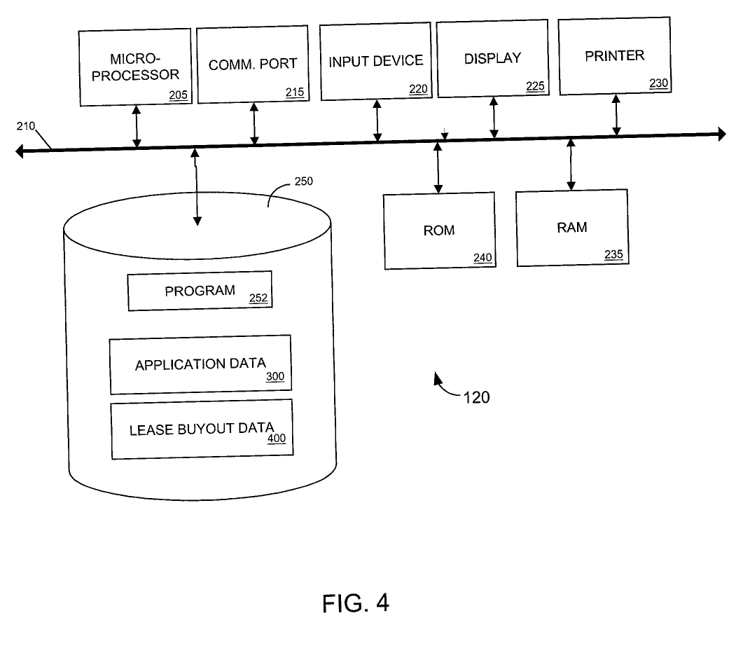

Details of one embodiment of sales device 120 will now be described by referring to FIG. 4 which is a block diagram of the internal architecture of an illustrative sales device 120. As illustrated, sales device 120 includes a microprocessor 205 in communication with a communication bus 210. Microprocessor 205 may be a Pentium, RISC-based, or other type of processor and is used to execute processor-executable process steps so as to control the elements of sales device 120 to provide desired functionality.

Also in communication with communication bus 210 is a communication port 215. Communication port 215 is used to transmit data to and to receive data from external devices, such as from one or more buyer devices 110. Communication port 215 is therefore preferably configured with hardware suitable to physically interface with desired external devices and/or network connections. In one embodiment, applications for a lease buyout product are received from buyer device 110 via the Internet through communication port 215. In another embodiment, applications for a lease buyout product are entered directly into seller device 120.

An input device 220, a display 225 and a printer 230 are also in communication with communication bus 220. Any known input device may be used as input device 220, including a keyboard, mouse, touch pad, voice-recognition system, or any combination of these devices.

Display 225, which may be an integral or separate CRT display, flat-panel display or the like, is used to output graphics and text to a user in response to commands issued by microprocessor 205. Such graphics and text may comprise a user interface as described herein. Printer 230 is an optional output device that produces a hardcopy of data using ink-jet, thermal, dot-matrix, laser, or other printing technologies. Printer 230 may be used to produce a hardcopy of application data or other data produced by or used with embodiments of the invention.

A random access memory (RAM) 235 is connected to communication bus 210 to provide microprocessor 205 with fast data storage and retrieval. In this regard, processor-executable process steps being executed by microprocessor 205 are typically stored temporarily in RAM 235 and executed there from by microprocessor 205. A read-only memory device (ROM) 240, in contrast, may be provided to permit storage from which data can be retrieved but to which data cannot be stored. Accordingly, ROM 240 is used to store invariant process steps and other data, such as basic input/output instructions and data used during system boot-up or to control communication port 215.

A data storage device 250 stores processor-executable process steps comprising a program 252. Microprocessor 205 executes processor-executable process steps of program 252 in order to perform the functions set forth herein.

The data stored in data storage device 250 may be in a compressed, uncompiled and/or encrypted format. Furthermore, stored in data storage device 250 may be program elements that may be necessary for operation of server 200, such as an operating system and “device drivers” for allowing microprocessor 205 to interface with devices in communication with communication port 215. These program elements are known to those skilled in the art, and need not be described in detail herein.

Data storage device 250 also stores information and data used to establish, process and generate lease buyouts pursuant to the present invention. For example, data storage device 250 may store an application database 300 and a lease buyout database 400. The databases and data stores are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

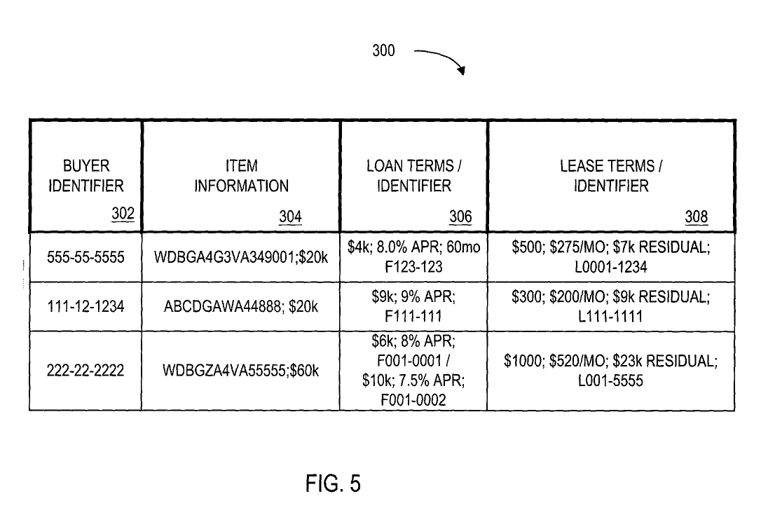

Referring to FIG. 5, a table represents an application database 300 that may be stored at, or accessible to, sales device 120 according to an embodiment of the present invention. The table includes entries identifying individual applicants for which lease buyout product applications are received. The table also defines a number of fields 302-308 for each of the entries. The fields specify: a buyer identifier 302, item information 304, loan terms/identifier 306, and lease terms/identifier 308. The information in database 300 may be created and updated, for example, based on information received from the individual applicant (e.g., via buyer device 110 or via sales device 120). Some or all of the information may also be received from financial institutions or other data sources.

Buyer identifier 302 may be, for example, an alphanumeric code associated with a particular individual who has requested (or who is being offered) a lease buyout financial product. Buyer identifier 302 may be generated by, for example, sales device 120, buyer device 110, or it may be equivalent to, based on, or related to information specifically identifying a particular individual. For example, in the example data shown in FIG. 5, the buyer's Social Security Numbers are used as the buyer identifier. Those skilled in the art will recognize that other information may also be used to particularly identify individuals for use with embodiments of the invention (e.g., the buyer's address, telephone number, and other contact information may also be provided).

Item information 304 may be, for example, data identifying the particular item which is being purchased by the buyer identified by the identifier set forth in buyer identifier 302. As discussed above, embodiments of the present invention may be used in the purchase of a number of different types of goods or services. In one particular use, embodiments of the invention are used to support the sales and purchase of automobiles. As shown in the examples set forth in FIG. 5, automobiles may be identified by their particular vehicle identifier number (VIN) and their purchase price. Those skilled in the art will recognize that other information may be used to particularly identify items being purchased using financing techniques of the invention.

Loan terms/identifier 306 includes, for example, information regarding one or more loans for purchasing the item specified by item information 304. In one embodiment, the information in 306 identifies a particular loan for which the buyer has been approved (e.g., the terms are fixed as an offer by a financial institution). In other embodiments, the information in 306 identifies potential loan terms that have not yet been fixed by a financial institution. Information in 306 may include terms such as: the amount of any down payment which is required; the price of the loan (e.g., the APR); the term of the loan (e.g., the number of months of the loan). A loan identifier may also be provided. The loan identifier may include information particularly identifying the loan offer as well as information particularly identifying the financial institution that offered the particular loan. Other information may be included as well.

Lease terms/identifier 308 includes, for example, information regarding one or more leases for purchasing the item specified by item information 304. In one embodiment, the information in 308 identifies a particular lease for which the buyer has been approved (e.g., the terms are fixed as an offer by a financial institution). In other embodiments, the information in 308 identifies potential lease terms that have not yet been fixed by a financial institution. Information in 308 may include terms such as: any fees which are required to enter into the lease; the monthly payment required; the term of the lease (e.g., the number of months of the lease); and the residual value of the financed item at the end of the lease term. A lease identifier may also be provided. The lease identifier may include information particularly identifying the lease offer as well as information particularly identifying the financial institution that offered the particular lease (if any). Other information may be included as well. Further, other information may be provided in application database 300 to particularly identify the buyer, the item, one or more loans, and one or more leases.

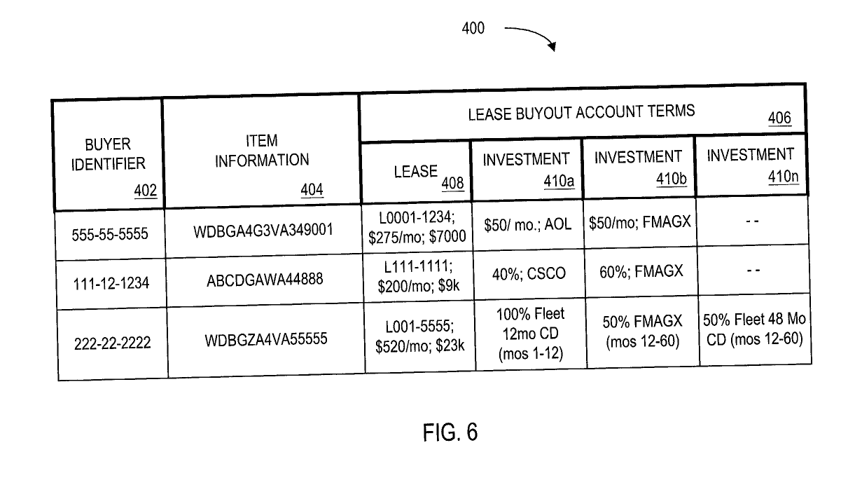

Referring to FIG. 6, a table represents lease buyout database 400 that may be stored at, or accessible to, sales device 120 according to an embodiment of the present invention. The table includes entries identifying one or more lease buyouts which have been established using techniques of the present invention. The table also defines fields 402-410 for each of the entries. The fields specify: a buyer identifier 402, item information 404, lease buyout terms 406 (including a lease identifier 408 and one or more investment identifiers 410a-n). The information in lease buyout database 400 may be created and updated, for example, based on information received from buyer device 110 and/or sales device 120. This information may be stored in database 400 once a buyer has accepted the terms and conditions of a lease buyout product pursuant to the present invention.

Buyer identifier 402 may be, for example, an alphanumeric code associated with a particular buyer who has accepted a lease buyout product pursuant to the invention. Buyer identifier 402 may be the same as, or related to, buyer identifier 302 of application database 300.

Item information 404 may be, for example, information identifying the item purchased by the buyer identified by buyer identifier 402 using a lease buyout product. This information may be the same as, or related to, item information 304 of application database 300. In the example data shown in FIG. 6, the items purchased are automobiles, and the item information 404 includes the vehicle VIN.

Lease buyout terms 406 include information identifying the terms of the lease buyout product which has been established for the buyer identified by buyer identifier 402 for purchase of the item identified by item information 404. In the example shown, the lease buyout terms include information identifying the lease 408 which has been entered into by the buyer for the item (including, for example, a lease identifier, the identity of the lessor, the amount of the lease, and the residual value of the item at the end of the lease). Lease buyout terms 406 may also include the identification of one or more investments 410a-n that have been established for the buyer identified by buyer identifier 402. Information about investments 410a-n may include, for example, the amount of the periodic payment that is made to a particular investment, the identity of the particular investment, and other information that particularly identifies one or more investment options that have been selected by the buyer. The information in lease buyout database 400 may be used to ensure that funds received from the buyer are properly allocated between the item lease and the investment option(s) selected by the buyer. Those skilled in the art will recognize that other types of data and information may be stored to identify lease buyouts of the present invention.

Although the present invention has been described with respect to a preferred embodiment thereof, those skilled in the art will note that various substitutions may be made to those embodiments described herein without departing from the spirit and scope of the present invention. For example, in some embodiments, the buyer may be given the opportunity to change investments during the term of the product (e.g., by redirecting some or all of the investment to other investment vehicles). In other embodiments, the buyer may be given the ability to use the investment at the end of the lease period for a purpose other than purchasing the vehicle. Further, in some embodiments, the buyer may be given the opportunity to select investments that appear to have a value of less than the residual value of the vehicle. Other embodiments and modifications will become apparent to those skilled in the art upon reading this disclosure.

What is claimed is:

1. A method for identifying an alternative financial product, comprising:
calculating a payment difference between a loan and a lease for an item, said loan and said lease having a term, said payment difference including at least a recurring payment difference equal to the difference between a recurring payment for said loan and a recurring payment for said lease;
identifying an investment option, said investment option having an expected rate of return; and
calculating an investment value at the end of said term based on investment of said payment difference in said investment option.

2. The method of claim 1, further comprising:
comparing said investment value with a residual value of said item at the end of said term.

3. The method of claim 2, further comprising:
offering said alternative financial product if said investment value is greater than or equal to said residual value,
said alternative financial product including said recurring lease payment and a recurring investment option payment.

4. The method of claim 3, wherein the sum of said recurring lease payment and said recurring investment option payment equals said recurring payment for said loan.

5. The method of claim 1, wherein said difference further includes an initial payment difference equal to the difference between an initial payment for said loan and an initial payment for said lease.

6. The method of claim 3, wherein said alternative financial product further includes an initial payment equal to an initial payment difference between an initial payment for said loan and an initial payment for said lease.

7. The method of claim 1, wherein said investment option includes at least one of: a stock; a bond; a mutual fund; a money market fund; and a certificate of deposit.

8. The method of claim 1, wherein said investment option includes a plurality of investments selected from: stocks, bonds, mutual funds, money market funds, and certificates of deposit.

9. The method of claim 1, further comprising:
receiving a payment for said alternative financial product;
applying a first portion of said payment to satisfy a recurring payment obligation for said lease; and
applying a second portion of said payment to increase a balance of said investment option.

10. An alternative financing method for an item, comprising:
identifying a loan for said item, said loan having a lump sum payment and a recurring loan payment over a term;
identifying a lease for said item, said lease having a recurring lease payment over said term and having a defined residual value for said item at the end of said term;
calculating a payment difference between said recurring lease payment and said recurring loan payment;
identifying an investment option, said investment option having an expected rate of return;
calculating an investment value at the end of said term based on investment of said payment difference in said investment option during said term; and
establishing said alternative financing method if said investment value is greater than or equal to said residual value.

11. The method of claim 10, further comprising:
receiving a periodic payment for said alternative financing method;
applying a first portion of said periodic payment to said recurring lease payment; and
applying a second portion of said periodic payment to increase a balance of said investment option.

12. A purchase method, comprising:
receiving a periodic payment for an item from a buyer;
identifying a lease agreement associated with said item and said buyer;
identifying a periodic lease payment amount;
applying a first portion of said periodic payment to said periodic lease payment;
identifying an investment option associated with said item and said buyer; and
applying a second portion of said periodic payment to increase a balance of said investment option.

13. The purchase method of claim 12, wherein said investment option is selected by identifying a residual amount of said item at an end of said lease agreement and identifying an investment amount and said investment option which will return an amount at least equal to said residual amount at said end of said lease agreement.

14. The purchase method of claim 12, wherein the amount of said second portion is selected by identifying a difference between said periodic lease payment amount and a loan payment amount for said item.

15. An apparatus for identifying an alternative financial product, the apparatus comprising:
a processor;
a communication device, coupled to said processor, receiving application data; and
a storage device in communication with said processor and storing instructions adapted to be executed by said processor to:
calculate a payment difference between a loan and a lease for an item, said loan and said lease having a term, said payment difference including at least a recurring payment difference equal to the difference between a recurring payment for said loan and a recurring payment for said lease;
identify an investment option, said investment option having an expected rate of return; and
calculate an investment value at the end of said term based on investment of said payment difference in said investment option.

16. The apparatus of claim 15, wherein said application data is received from a buyer device.

17. The apparatus of claim 15, wherein said application is received from an input device.

18. An apparatus for conducting an alternative financing technique, the apparatus comprising:
a processor;
a communication device, coupled to said processor, receiving application data; and
a storage device in communication with said processor and storing instructions adapted to be executed by said processor to:
identify, based at least in part on said application data, a loan for an item, said loan having a lump sum payment and a recurring payment over a term;
identify, based at least in part on said application data, a lease for said item, said lease having a recurring lease payment over said term and having a defined residual value for said item at the end of said term;
calculate a payment difference between said recurring lease payment and said recurring loan payment;
identify an investment option, said investment option having an expected rate of return;
calculate an investment value at the end of said term based on investment of said payment difference in said investment option during said term; and
establish said alternative financing technique if said investment value is greater than or equal to said residual value.

19. The apparatus of claim 18, where said storage device further stores instructions adapted to be executed by said processor to:
receive a payment for said alternative financial technique;
apply a first portion of said payment to satisfy a recurring payment obligation for said lease; and
apply a second portion of said payment to increase a balance of said investment option.

20. The apparatus of claim 18, wherein said application data is received from a buyer device.

21. The apparatus of claim 20, wherein said buyer device is in communication with said communication device via a network connection.

22. A system for evaluating an application for an alternative financial product, the system comprising:
at least a first buyer device having
a processor;
a communication device, coupled to said processor, configured to send and receive data over a network; and
a storage device in communication with said processor and storing instructions adapted to be executed by said processor to
forward application data to an at least first sales device; said at least first sales device having
a second processor,
a second communication device, coupled to said second processor, configured to send and receive data over said network and to receive said application data; and
a second storage device in communication with said second processor and storing instructions adapted to be executed by said second processor to
identify, based at least in part on said application data, a loan for an item, said loan having a lump sum payment and a recurring payment over a term;
identify, based at least in part on said application data, a lease for said item, said lease having a recurring lease payment over said term and having a defined residual value for said item at the end of said term;
calculate a payment difference between said recurring lease payment and said recurring loan payment;
identify an investment option, said investment option having an expected rate of return;
calculate an investment value at the end of said term based on investment of said payment difference in said investment option during said term; and
generate terms and conditions for said alternative financing technique if said investment value is greater than or equal to said residual value.

23. The system of claim 22, wherein said second storage device further stores instructions adapted to be executed by said second processor to:
forward said terms and conditions of said alternative financing technique to said at least first buyer device.

24. The system of claim 23, wherein said first storage device further stores instructions adapted to be executed by said first processor to:
present said terms and conditions to a buyer; and
forward an acceptance of said terms and conditions to said at least first sales device.

25. The system of claim 24, wherein said acceptance is received by said at least first sales device and said second storage device further stores instructions adapted to be executed by said second processor to establish said alternative financing technique.

26. A computer program product in a computer readable medium for identifying an alternative financial product, comprising:
first instructions for calculating a payment difference between a loan and a lease for an item, said loan and said lease having a term, said payment difference including at least a recurring payment difference equal to the difference between a recurring payment for said loan and a recurring payment for said lease;
second instructions for identifying an investment option, said investment option having an expected rate of return; and
third instructions for calculating an investment value at the end of said term based on investment of said payment difference in said investment option.

23. A system for identifying an alternative financial product, comprising:
means for calculating a payment difference between a loan and a lease for an item, said loan and said lease having a term, said payment difference including at least a recurring payment difference equal to the difference between a recurring payment for said loan and a recurring payment for said lease;
means for identifying an investment option, said investment option having an expected rate of return; and
means for calculating an investment value at the end of said term based on investment of said payment difference in said investment option.

24. A purchasing system, comprising:
means for receiving a periodic payment for an item from a buyer;
means for identifying a lease agreement associated with said item and said buyer;
means for identifying a periodic lease payment amount;
means for applying a first portion of said periodic payment to said periodic lease payment;
means for identifying an investment option associated with said item and said buyer; and
means for applying a second portion of said periodic payment to increase a balance of said investment option.
